(19) United States
(12) Patent Application Publication
(10) Pub. No.: US 2026/0252523 A1
(43) Pub. Date: Aug. 27, 2026

(54) DISPLAY DEVICE AND NETWORKING METHOD THEREOF

(71) Applicant: Wistron Corporation, New Taipei City (TW)

(72) Inventors: Lei Sun, New Taipei City (TW); Yuan Yuan Cai, New Taipei City (TW); Lei Yang, New Taipei City (TW); Wenlong Yang, New Taipei City (TW); Junxin Qiu, New Taipei City (TW)

(73) Assignee: Wistron Corporation, New Taipei City (TW)

(21) Appl. No.: 19/074,430

(22) Filed: Mar. 9, 2025

(30) Foreign Application Priority Data
Feb. 21, 2025 (CN) 202510199893.5

(51) Int. Cl. G06F 13/42

(52) U.S. Cl. CPC G06F 13/4282; G06F 2213/0042

(57) ABSTRACT

Provided are a display device and a networking method thereof. The display device includes a hub, a universal serial bus (USB) port, a switching circuit, a network interface controller (NIC), and a display control device. The switching circuit is controlled by a control signal. In response to the control signal being in a first state, the USB port is connected to a network through the hub, the switching circuit, and the NIC. In response to the control signal being in a second state, the display control device is connected to the network through the switching circuit and the NIC.

### CROSS-REFERENCE TO RELATED APPLICATION

This application claims the priority benefit of China application serial no. 202510199893.5, filed on Feb. 21, 2025. The entirety of the foregoing patent application is hereby incorporated by reference herein and made a part of this specification.

### BACKGROUND

### Technical Field

The disclosure relates to a corresponding technology of a display device, and in particular relates to a display device and a networking method.

### Description of Related Art

With the development of technology, more and more displays in the market are equipped with universal serial bus (USB) Type-C interface and Ethernet network port (such as RJ45 network port) as a signal input and network connection interface. Electronic devices (such as laptops, tablets, smartphones) may be connected to the display through the USB Type-C interface to serve as a signal source of the display. In addition, the display may also be connected to a regional network (such as a wireless router) through the RJ45 network port or related wireless modules to enjoy multimedia network streaming services.

Since displays gradually develop towards artificial intelligence of things (AIoT) technology, the functions of the displays are gradually diversified, leading to a gradual increase in the hardware cost in the displays as well.

### SUMMARY

The disclosure provides a display device and a networking method thereof. A circuit structure utilized by the display device may save the hardware establishment cost.

The display device according to an embodiment of the disclosure includes a hub, a universal serial bus (USB) port, a switching circuit, a network interface controller (NIC) and a display control device. The USB port is coupled to the hub. The switching circuit is coupled to the hub. The switching circuit is controlled by a control signal. The network interface controller is coupled to the switching circuit. The display control device is coupled to the hub. In response to the control signal being in a first state, the USB port is connected to a network through the hub, the switching circuit and the network interface controller. In response to the control signal being in a second state, the display control device is connected to the network through the switching circuit and the network interface controller.

In the networking method of the display device according to an embodiment of the disclosure, the display device includes a hub, a universal serial bus (USB) port, a switching circuit, a network interface controller, and a display control device. The networking method includes: the USB port is connected to a network through the hub, the switching circuit and the network interface controller in response to a control signal being in a first state; and the display control device is connected to the network through the switching circuit and the network interface controller in response to the control signal being in a second state.

Based on the above, the display device of the embodiment may allow the electronic device to access the internet in a wired network manner through the USB port and the NIC with a USB signal transmission function without performing networking through the microprocessor in the display control device. Therefore, in a condition where the microprocessor in the display device does not need to have a networking function, the hardware establishment cost of the display device may be saved.

### BRIEF DESCRIPTION OF THE DRAWINGS

FIG. 1 is a block diagram of a display device according to an embodiment of the disclosure.

FIG. 2 is a schematic diagram of the display device in FIG. 1 in a condition where a control signal is a first state.

FIG. 3 is a schematic diagram of the display device in FIG. 1 in a condition where a control signal is a second state.

FIG. 4 is a schematic diagram of an on-screen display (OSD) menu in the display device in FIG. 1.

FIG. 5 is a flow chart of a networking method of a display device according to an embodiment of the disclosure.

FIG. 6 is another block diagram of a display device according to an embodiment of the disclosure.

FIG. 7 is a schematic structural diagram of a scaler, a microprocessor and related program codes of a display device according to an embodiment of the disclosure.

### DESCRIPTION OF THE EMBODIMENTS

A display device of each embodiment of the disclosure may be connected to a cloud network or Ethernet without other electronic devices (such as personal computers or laptops). In addition, the display device may implement related applications by itself through the cloud network, such as firmware update, self-function assessment and diagnosis, remote debugging, functions related to artificial intelligence (AI), energy-saving adjustment, and power consumption reporting related to ESG (an abbreviation for Environmental, Social, and Governance) . . . etc.

Moreover, if the display device may be connected to the network through the Ethernet port, each embodiment of the disclosure may further allow an electronic device to be connected to the foregoing network through the USB Type-C interface on the display device. In other words, the display device may allow the electronic device to access the internet in a wired network manner through the USB Type-C interface and the network interface controller (NIC) with a USB signal transmission function. The control module or microprocessor in the display device does not need to have a networking function (also referred to as a media access control (MAC) function) to allow the electronic device to access the internet as well, thereby saving the hardware establishment cost of the display device in a condition where the display device has the networking function. Each embodiment compatible with the disclosure is proposed below.

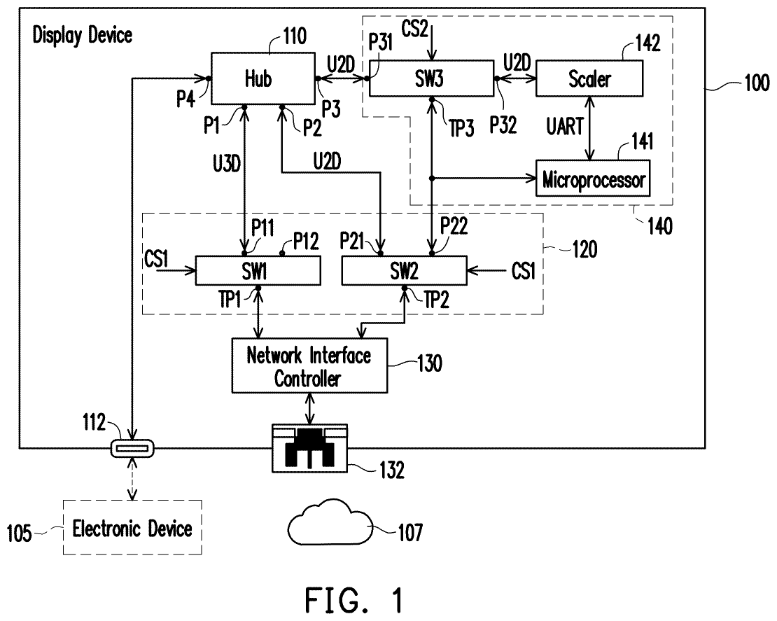

FIG. 1 is a block diagram of a display device 100 according to an embodiment of the disclosure. The display device 100 may be a screen display, a liquid crystal panel or a smart TV. The display device 100 may present multimedia data, such as frames, images, audio . . . , from a signal source. The foregoing signal source may be an electronic device connected to a USB port (such as a smartphone, a laptop, a multimedia streaming service on the network and a corresponding server).

The display device 100 mainly includes a hub 110, a USB port 112, a switching circuit 120, a network interface controller (NIC) 130, and a display control device 140. The display device 100 may further include an Ethernet port 132 (such as a RJ45 port) and a display screen (not shown).

The hub 110 includes a first end P1, a second end P2, a third end P3, and a transmission end P4. The USB port 112 is coupled to the transmission end P4 of the hub 110. The USB port 112 of the embodiment may also be referred to as a USB upstream port.

The switching circuit 120 is coupled or electrically connected to the hub 110. The switching circuit 120 is controlled by a control signal CS1. In an embodiment, the switching circuit 120 in FIG. 1 may include a first switch SW1 and a second switch SW2. A first connection end P11 of the first switch SW1 is coupled to the first end P1 of the hub 110, and a control end of the first switch SW1 receives the control signal CS1. A first connection end P21 of the second switch SW2 is coupled to the second end P2 of the hub 110, and a control end of the second switch SW2 receives the control signal CS1. A communication end of the NIC 130 is coupled to the Ethernet port 132 to be connected to a network 107. A first transmission end of the NIC 130 is coupled to a transmission end TP1 of the first switch SW1. A second transmission end of the NIC 130 is coupled to a transmission end TP2 of the second switch SW2. In an embodiment, the first switch SW1 is compatible with a USB3 version in a USB protocol and utilizes the USB3 version to transmit data. The second switch SW2 is compatible with a USB2 version in the USB protocol and utilizes the USB2 version to transmit data.

The NIC 130 is coupled to the Ethernet port 132 to be connected to the network 107 through a wired network cable. The NIC 130 is coupled to the switching circuit 120. In an embodiment, the NIC 130 utilizes the USB3 version and the USB2 version of the USB protocol to transmit data.

In a condition where the control signal CS1 is in a first state (such as an enabled state), an electronic device 105 connected to the USB port 112 is connected to the network 107 through the hub 110, the switching circuit 120 and the NIC 130. The electronic device 105 is, for example, a smartphone, a personal computer, a notebook computer, a tablet computer...etc. In other words, the electronic device 105 of the embodiment may be connected to the network 107 through the display device 100.

On the other hand, in a condition where the control signal CS1 is in a second state (such as a disabled state), the display control device 140 is connected to the network 107 through the switching circuit 120 and the network interface controller 130. For example, a microprocessor 141 in the display control device 140 may upload data of the display device 100 to a server on the network 107 to perform self-function assessment and diagnosis, remote debugging, AI-related function, energy saving adjustment, and ESG-related power consumption reporting...etc. The microprocessor 141 in the display control device 140 may obtain firmware update data from the server on the network 107, and determine whether to perform a firmware update on the display device 100 according to the firmware update data.

In an embodiment, the display control device 140 includes the microprocessor (MCU) 141, a scaler 142 and a third switch SW3. The microprocessor 141 is coupled to a second connection end P22 of the second switch SW2 in the switching circuit 120. The scaler 142 is coupled to the microprocessor 141. In an embodiment, the scaler 142 communicates with the microprocessor 141 through a universal asynchronous receiver and transmitter protocol (UART). A first connection end P31 of the third switch SW3 is coupled to the third end P3 of the hub 110. A second connection end P32 of the third switch SW3 is coupled to the scaler 142, and a transmission end TP3 of the third switch SW3 is coupled to the second connection end P22 of the second switch SW2.

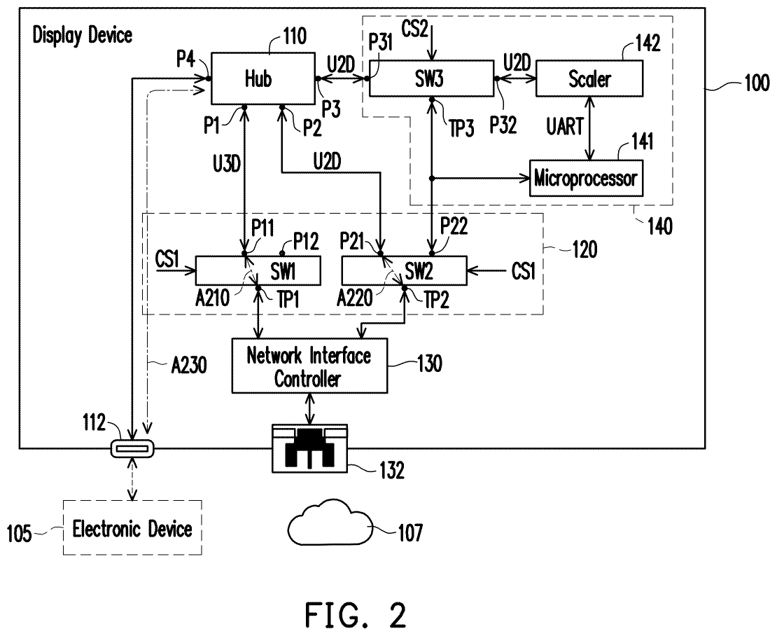

FIG. 2 is a schematic diagram of the display device 100 in FIG. 1 in the condition where the control signal CS1 is in the first state. In the condition where the control signal CS1 is in the first state (such as the enabled state), the transmission end TP1 of the first switch SW1 is coupled to the first connection end P11 (as shown by an arrow A210), and the transmission end TP2 of the second switch SW2 is coupled to the first connection end P21 (as shown by an arrow A220). The electronic device 102 may be coupled to the hub 110 through the USB port 112, as shown by an arrow A230. Therefore, through adjusting a firmware and a function of the NIC 130, the electronic device 102 may be connected to the network 107 through the hub 110, one of the first switch SW1 and the second switch SW2, and the NIC 130. In an embodiment, data is transmitted between the hub 110 and the first switch SW1 based on a USB3 version in a transmission protocol U3D. Data is transmitted between the hub 110 and the second switch SW2 of the embodiment based on a USB2 version of a transmission protocol U2D.

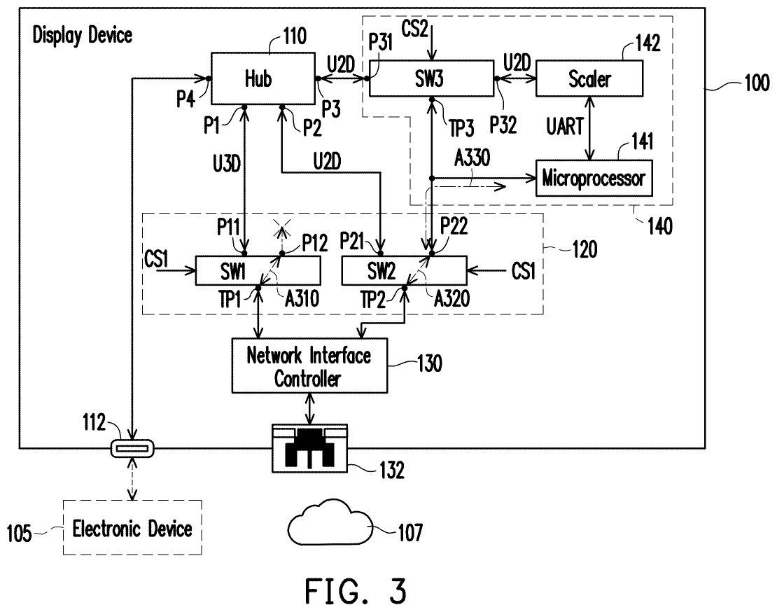

FIG. 3 is a schematic diagram of the display device 100 in FIG. 1 in the condition where the control signal CS1 is in the second state. In the condition where the control signal CS1 is in the second state (such as the disabled state), the transmission end TP1 of the first switch SW1 is coupled to the second connection end P12 (as shown by an arrow A310), and the second connection end P12 is not coupled to other elements. On the other hand, the transmission end TP2 of the second switch SW2 is coupled to the second connection end P22 (as shown by an arrow A320). The microprocessor 141 in the display control device 140 is connected to the network 107 through the second switch SW2 and the NIC 130. In an embodiment, the microprocessor 141 may process data of the USB2 version in the USB protocol, so data is transmitted between the microprocessor 141 and the second switch SW2 based on the USB2 version of the transmission protocol U2D, as shown by an arrow A330.

Therefore, according to the embodiment, corresponding elements that do not have networking functions may be selected to implement the microprocessor 141, and there is no need to use a regional network (LAN) exchanger with a higher cost to implement the switching circuit 120. When the microprocessor in the display control device 140 has a need for networking, the network 107 may be connected through the NIC 130. In this way, the hardware establishment cost of the microprocessor 141 may be saved in a condition where the need for the display device 100 to have a networking function is met.

In other embodiments compatible with the disclosure, the microprocessor 141 that may process data of the USB3 version in the USB protocol may also be selected, and the switching circuit 120 may be implemented using a switch that may process the data of the USB3 version in the USB protocol. That is, the transmission end TP1 of the first switch SW1 may be coupled to the microprocessor 141 through the second connection end P12.

The third switch SW3 is compatible with the USB2 version in the USB protocol to transmit data. The third switch SW3 is controlled by a switch signal CS2. When the electronic device 105 is served as a signal source, the control signal CS2 may be enabled, and the first connection end P31 of the third switch SW3 is coupled to the transmission end TP3. In this way, the electronic device 105 may transmit data to the scaler 142 to present corresponding multimedia data. On the other hand, when the scaler 142 needs to receive data from the network 107, the control signal CS2 may be disabled, and the second connection end P32 of the third switch SW3 is coupled to the transmission end TP3. In this way, the scaler 142 may transmit data through the third switch SW3 and the second switch SW2 and based on the USB2 version of the transmission protocol U2D.

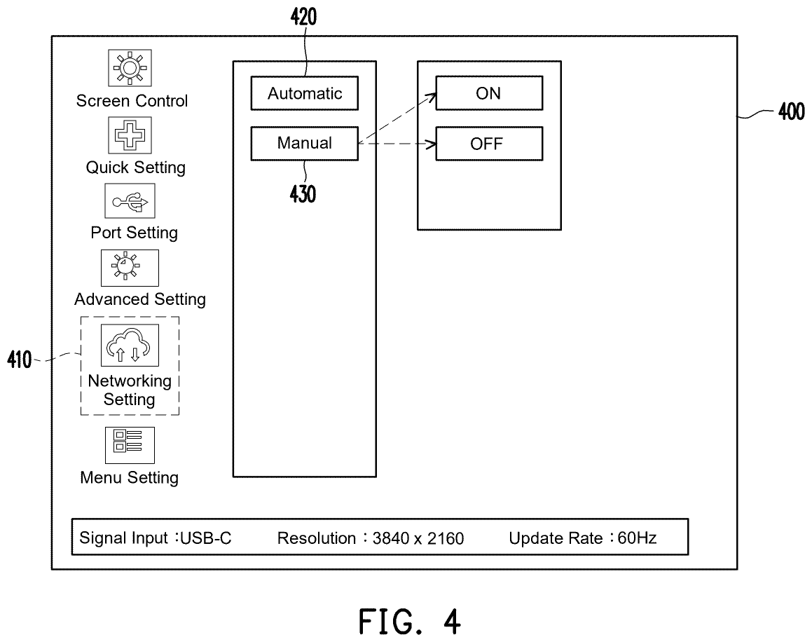

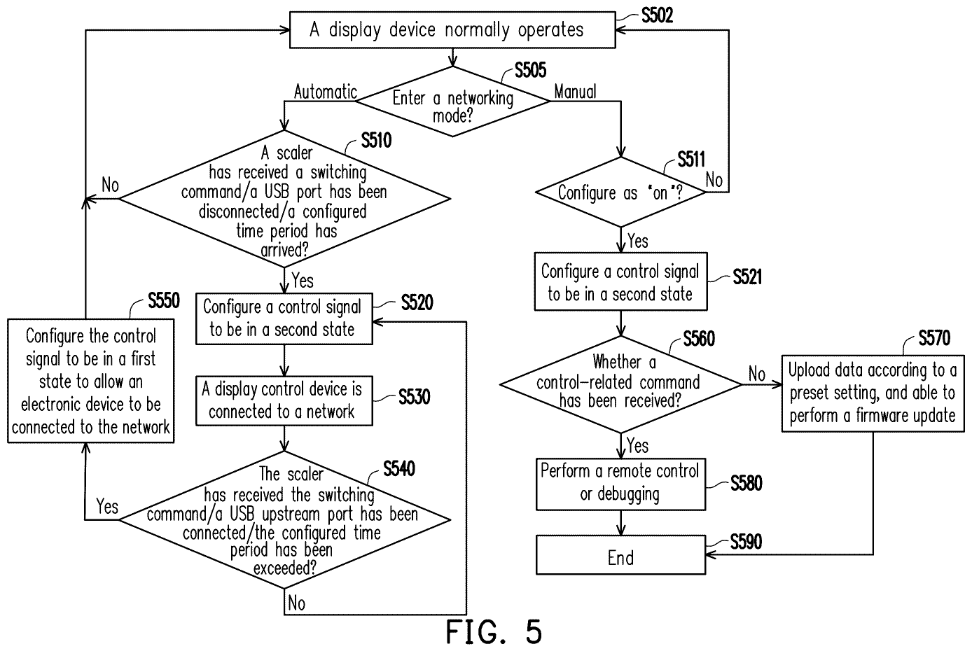

The first switch SW1 and the second switch SW2 are both controlled by the control signal CS1. The control signal CS1 in the embodiment may be controlled by one or a combination of the microprocessor 141 and the scaler 142, depending on how to implement control on the control signal CS1. In other words, there are various implementations for a switching mechanism of the control signal CS1, for example, through an application (APP) connected to the display device 100 to adjust the control signal CS1 through the microprocessor 141, through a corresponding control technology of a high-definition multimedia interface (HDMI) (such as video data mapping (VDM), high-definition digital content protection (HDCP) . . . etc.) to adjust the control signal CS1 through the scaler 142, and through controlling function options of an on-screen display (OSD) menu and configuring a time period to adjust the control signal CS1 through the scaler 142 or the microprocessor 141. Here, controlling the function options of the on-screen display (OSD) menu to adjust the control signal is taken as an example to illustrate FIG. 4 and FIG. 5.

FIG. 4 is a schematic diagram of an on-screen display (OSD) menu 400 in the display device 100 in FIG. 1. A user may select a “networking setting mode 410” in the OSD menu 400, and adjust the networking setting mode 410 to an automatic mode 420 or a manual mode 430 according to the user's needs. Also, the manual mode 430 may be configured to be on or off. A networking method of the display device according to the embodiment (such as the “networking setting mode 410”) may adjust the corresponding mode according to the foregoing method, thereby selectively adjusting a determining behavior mode of the control signal CS1.

FIG. 5 is a flow chart of a networking method of a display device according to an embodiment of the disclosure. Please refer to FIG. 1 and FIG. 5 at the same time. In step S502, the display device (such as the display device 100 in FIG. 1) normally operates. In step S505, which type of networking mode to be entered is determined, for example, the automatic or manual networking mode. The setting of the networking mode may be adjusted by the foregoing FIG. 4 and the corresponding embodiment.

When the automatic mode of the networking mode is entered, step S505 is entered into step S510 to determine whether to adjust the control signal to be in the first state or the second state through corresponding determining conditions. For example, the scaler 142 in the display device 100 may receive a switching command through corresponding control technologies of the high-definition multimedia interface (HDMI) (such as video data mapping (VDM), high-definition digital content protection (HDCP) . . . etc.); alternately, whether the USB port 112 has been disconnected from the electronic device 105 based on a connection pin of the USB port 112; alternately, the user may set one or more configured time periods in the display device 100, and the display device 100 may determine whether a current time has reached the foregoing configured time period. Those who apply the embodiment may adjust the determining conditions in step S510 according to needs, and the determining conditions may be implemented one by one, or combined with each other utilizing logical computations.

When one of the foregoing steps S510 is yes, step S520 is entered, configuring the control signal to be in the second state. Then, in step S530, the display control device 140 is connected to the network 107 through the second switch SW2 in the switching circuit 120 and the network interface controller 130. After the display control device 140 is connected to the network 107, the data of the display device 100 may be uploaded to the server on the network 107 through the microprocessor 141 in the display control device 140, and may correspondingly perform corresponding operations.

In step S540, similar to various determining conditions in step S510, for example, the scaler 142 in the display control device 140 has received the switching command again, the USB port 112 and the electronic device 105 have been disconnected, or the current time has exceeded the configured time period . . . etc. When the determining condition of step S540 is yes, step S540 is entered into step S550, configuring the control signal CS1 to be in the first state to allow the electronic device 105 to be connected to the network 107.

When the manual mode of the networking mode is entered, step S505 is entered into step S511 to determine whether the manual mode is “on” or “off”. If the manual mode is “off” (step S511 is “No”), it means that the user does not use the networking method of the embodiment, and then S511 is returned to step S502. If the manual mode is “on” (step S511 is “yes”), step S521 is entered, configuring the control signal to be in the second state. Then, in step S560 to step S590, the display control device 140 is connected to the network 107 through the second switch SW2 in the switching circuit 120 and the network interface controller 130, and may perform operations, such as firmware update . . . , of the display device.

For example, in step S560, it is determined whether the scaler 142 has received a control-related command from the network 107 or a corresponding application, or whether a remote debugging command has been received. If no corresponding instruction is received, step S560 is entered into step S570. According to a preset setting, the scaler 142 uploads the data of the display device 100 to the server on the network 107 through the microprocessor 141. Furthermore, the scaler 142 may obtain a firmware update data from the server on the network through the microprocessor 141 and decide whether to perform a firmware update.

On the other hand, if the corresponding instruction is received, step S560 is entered into step S580. The scaler 142 executes an operation according to the received command and feeds back related register data or debugging information to the server on the network to perform a remote control or debugging. After step S570 and step S580 are executed, step S590 is entered to end the networking method.

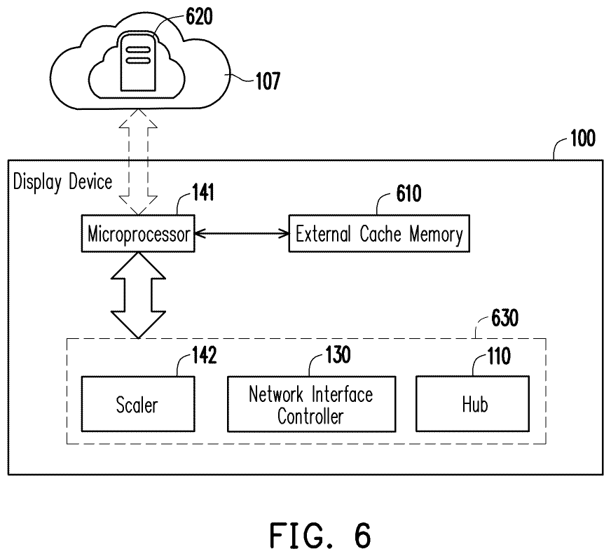

FIG. 6 is another block diagram of the display device 100 according to an embodiment of the disclosure. In addition to the microprocessor 141, the scaler 142, the network interface controller 130 and the hub 110, the display device 100 in FIG. 6 further includes an external cache memory 610. When the microprocessor 141 is successfully connected to a server 620 on the network 107, the microprocessor 141 obtains a latest firmware update data pushed by the server 620. Each chip or element (such as an element set 630) inside the microprocessor 620 or the display device 100 individually checks its own firmware version and compares with the version in the foregoing firmware update data. If one of the elements finds its own firmware version to be older, a firmware update may be performed through the microprocessor 141. The firmware update in the embodiment may be implemented in a background procedure of the display device 100, so it does not affect a normal operation of the display device 100.

In an embodiment, the microprocessor may select a chip with a model GD32E50X. The chip does not have a networking function, and has a USB2 version of a data transmission interface and supports a USB OTG (On-The-Go) standard. The network interface controller 130 may select a chip with a model RTL8156.

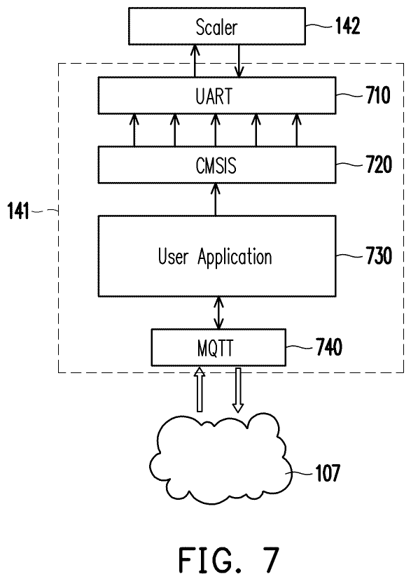

FIG. 7 is a schematic structural diagram of the scaler 142, the microprocessor 141 and related program codes of the display device 100 according to an embodiment of the disclosure. As shown in FIG. 7, the scaler 142 and the microprocessor 141 communicate with each other through a universal asynchronous receiver and transmitter protocol UART 710. In an embodiment, the microprocessor 141 does not have an operating system, but utilizes a low-level command in the network technology and USB technology to implement the operation.

For example, in an embodiment, the microprocessor 141 runs a common module for industrial smart infrastructure services (CMISIS) 720, a user application 730, and a message queuing telemetry transport (MQTT) 740. The user application 730 communicates with the scaler 142 through the CMISIS 720 and the UART 710 to implement corresponding functions. On the other hand, the user application 730 is connected to the network 107 through the MQTT 740.

The program codes in the user application 730 may include multiple procedures, such as a main procedure main.c, a first procedure usbh_usr.c, a second procedure gd32e51x_it.c, a third procedure gd32e51x_usb_hw.c, and a fourth procedure netconf.c. The main procedure main.c serves as an entrance of the procedures, which includes a main function and is a starting point of the procedures.

The first procedure usbh_usr.c mainly defines a change data capture (CDC) type of processing functions, such as device connection, descriptor processing, speed detection, data sending and receiving processing . . . and a series of data transmission and processing functions. Through the functions, the user may implement a communication operation with an electronic device (such as an equipment or a host with a USB interface).

The second procedure gd32e51x_it.c mainly defines related functions of an interrupt service program to handle various interrupt events. The third procedure gd32e51x_usb_hw.c mainly defines a hardware-related initialization and a configuration program code. The fourth procedure netconf.c mainly defines a program code related to a network configuration, such as related functions configured to define a control of a dynamic host configuration protocol (DHCP), a network interface initialization, a network function update, and a management and control of the DHCP state machine processing functions . . . etc. Through the program code in the fourth procedure netconf.c, an IP address may be dynamically obtained, a network interface may be initialized, and various network communication tasks may be processed.

In an embodiment, the first procedure usbh_usr.c is mainly configured to get through the microprocessor 141 and the network interface controller 130 to perform networking, and process various parameters needed for networking through CDC type processing functions, thereby implementing the transmission and receiving of data.

To sum up, the display device of each embodiment of the disclosure may allow the electronic device to access the internet through the USB Type-C interface and the network interface controller (NIC) with the USB signal transmission function in a wired network manner. The control module or the microprocessor in the display device does not need to have the networking function (also referred to as the media access control (MAC) function) to allow the electronic device to access the internet, thereby saving the hardware establishment cost of the display device in the condition where the display device has the networking function.

What is claimed is:

1. A display device, comprising:
a hub;
a universal serial bus (USB) port, coupled to the hub;
a switching circuit, coupled to the hub, wherein the switching circuit is controlled by a control signal;
a network interface controller, coupled to the switching circuit; and
a display control device, coupled to the hub,
wherein in response to the control signal being in a first state, the USB port is connected to a network through the hub, the switching circuit and the network interface controller, and
in response to the control signal being in a second state, the display control device is connected to the network through the switching circuit and the network interface controller.

2. The display device according to claim 1, wherein the switching circuit comprises:
a first switch, coupled to the hub, and the first switch is controlled by the control signal; and
a second switch, coupled to the hub, and the second switch is controlled by the control signal,
wherein in response to the control signal being in the first state, the USB port is connected to the network through the hub, one of the first switch and the second switch, and the network interface controller, and
in response to the control signal being in the second state, the display control device is connected to the network through the second switch and the network interface controller.

3. The display device according to claim 2, wherein the network interface controller utilizes a USB3 version and a USB2 version in a USB protocol to transmit data,
the first switch is compatible with the USB3 version, and the second switch is compatible with the USB2 version.

4. The display device according to claim 3, wherein an electronic device connected to the USB port communicates with the network interface controller based on one of the USB3 version and the USB2 version.

5. The display device according to claim 1, wherein the display control device comprises:
a microprocessor, coupled to the switching circuit;
a scaler, coupled to the microprocessor; and
a third switch, coupled the switching circuit and the hub,
wherein in response to the control signal being in the second state, the microprocessor is connected to the network through the switching circuit and the network interface controller.

6. The display device according to claim 5, wherein the third switch is compatible with a USB2 version in a USB protocol.

7. The display device according to claim 5, the microprocessor does not have a networking function.

8. The display device according to claim 5, wherein the microprocessor uploads data of the display device to a server on the network.

9. The display device according to claim 5, wherein the microprocessor obtains firmware update data from a server, and determines whether to perform a firmware update on the display device according to the firmware update data.

10. The display device according to claim 5, wherein the control signal is controlled by one or a combination of the microprocessor and the scaler.

11. The display device according to claim 5, wherein the microprocessor obtains firmware update data from a server on the network, and determines whether to perform a firmware update on the display device according to the firmware update data.

12. A networking method of a display device, wherein the display device comprises a hub, a universal serial bus (USB) port, a switching circuit, a network interface controller, and a display control device, and the networking method comprises:
connecting the USB port to a network through the hub, the switching circuit and the network interface controller in response to a control signal being in a first state; and
connecting the display control device to the network through the switching circuit and the network interface controller in response to the control signal being in a second state.

13. The networking method according to claim 12, further comprising:
determining whether a networking mode is in a manual mode or an automatic mode; and
adjusting the control signal to be in the first state or the second state according to the manual mode or the automatic mode.

14. The networking method according to claim 13, wherein steps of adjusting the control signal to be in the first state or the second state according to the manual mode or the automatic mode comprise:
determining whether a scaler in the display control device has received a switching command, whether the USB port has been disconnected from an electronic device, or whether a time is already in a configured time period in the automatic mode;
in a condition where the scaler in the display control device has received the switching command, the USB port has been disconnected from the electronic device, or the time is already in the configured time period, the control signal is configured to be in the second state to allow the display control device to be connected to the network; and
in a condition where the scaler in the display control device has not received the switching command, the USB port has not been disconnected from the electronic device, or the time is not in the configured time period, the control signal is configured to be in the first state to allow the electronic device to be connected to the network.

15. The networking method according to claim 12, wherein steps of connecting the display control device to the network comprise:
uploading data of the display device to a server on the network through a microprocessor in the display control device.

16. The networking method according to claim 12, wherein steps of connecting the display control device to the network comprise:
obtaining firmware update data from a server on the network; and
determining whether to perform a firmware update on the display device according to the firmware update data.

17. The networking method according to claim 12, wherein the switching circuit comprises:
a first switch, controlled by the control signal; and
a second switcher, controlled by the control signal,
wherein in response to the control signal being in the first state, the USB port is connected to the network through the hub, one of the first switch and the second switch, and the network interface controller, and
in response to the control signal being in the second state, the display control device is connected to the network through the second switch and the network interface controller.

18. The networking method according to claim 17, wherein the network interface controller utilizes a USB3 version and a USB2 version in a USB protocol to transmit data,
the first switch is compatible with the USB3 version, and the second switch is compatible with the USB2 version, and
an electronic device connected to the USB port communicates with the network interface controller based on one of the USB3 version and the USB2 version.

19. The networking method according to claim 12, wherein the display control device comprises:
a microprocessor, coupled to the switching circuit;
a scaler, coupled to the microprocessor; and
a third switch, coupled the switching circuit and the hub,
wherein in response to the control signal being in the second state, the microprocessor is connected to the network through the switching circuit and the network interface controller,
wherein the third switch is compatible with a USB2 version in a USB protocol.

20. The networking method according to claim 19, wherein the microprocessor does not have a networking function.
